(19) United States
(12) Patent Application Publication
(10) Pub. No.: US 2005/0246081 A1
(43) Pub. Date: Nov. 3, 2005

(54) Method and system to prevent unintended rolling of a vehicle

(76) Inventors: Christophe Bonnet, Stuttgart (DE); Jens Desens, Korb (DE)

Correspondence Address: FASSE PATENT ATTORNEYS, P.A., P.O. BOX 726, HAMPDEN, ME, 04444-0726, US

(21) Appl. No.: 11/103,694

(22) Filed: Apr. 11, 2005

(30) Foreign Application Priority Data
Apr. 10, 2004 (DE) 10 2004 017 635.3

(51) Int. Cl. G06F 7/00

(52) U.S. Cl. 701/38; 280/5.502

(57) ABSTRACT

A method of blocking the unintended rolling of a vehicle involves detecting any actual vehicle motion, detecting a selected transmission gear, determining whether an unintended rolling of the vehicle is occurring or is expected to occur based on the vehicle motion and the selected gear, and automatically activating a roll-blocking device such as a brake if the unintended rolling is actually occurring or expected to occur. Further operating parameters or conditions of the vehicle and a slope angle of the terrain on which the vehicle is located can additionally be taken into account in determining whether the unintended rolling is occurring or expected to occur. A system for this includes a roll-blocking device, a driving state determination arrangement, a gear recognition arrangement, and a control unit connected to the above.

### PRIORITY CLAIM

This application is based on and claims the priority under 35 U.S.C. §119 of German Patent Application 10 2004 017 635.3, filed on Apr. 10, 2004, the entire disclosure of which is incorporated herein by reference.

### FIELD OF THE INVENTION

The invention relates to a method as well as a system for blocking or preventing the unintended rolling of a vehicle, in which a roll-blocking device is automatically activated upon recognition of a prescribed state or condition.

### BACKGROUND INFORMATION

As is generally known, a motor vehicle can roll unintentionally or contrary to the desires or intentions of the driver. Such unintended rolling can especially occur during slow forward or reverse driving, or starting to drive from a standstill, of a motor vehicle on steeply sloping terrain or on a sloping grade of a roadway. Particularly, such unintended rolling can occur and becomes problematic or dangerous for heavy trucks or off-road vehicles, such as the DaimlerChrysler AG “UNIMOG” universal motor truck, for example.

Such unintended rolling of a vehicle can occur, for example, through inappropriate combinations of the driver's operation of gear shift levers, a driving pedal such as the accelerator or gas pedal, a brake pedal, a hand operated parking brake, a clutch if applicable, or the like. As a particular example, an inexperienced driver may find it difficult to appropriately and rapidly operate the brake pedal, the clutch pedal, the accelerator, the gear shift lever, etc. in order to start driving up a slope from a standstill, without unintentionally rolling downhill during the initial clutch engagement process or during further clutch disengagements. Another example of such unintended rolling occurs when a too-high gear range is selected for traveling up a given slope, so that the vehicle's engine is unable to produce the required torque and begins to “bog down”. When that happens, the driver instinctively steps on, and thus disengages, the clutch, to prevent the overloaded engine from stalling, but at that moment of clutch disengagement, the vehicle can begin to roll back down the slope.

The unintended rolling of a vehicle is especially dangerous if it occurs in a direction opposite or contrary to the driving direction intended by the driver. Furthermore, such unintended rolling is especially critical and dangerous on steep slopes or grades, for example a slope or grade of 40°, whereby the vehicle can quickly gain substantial rolling speed before brakes or other measures can be applied in an attempt to stop the vehicle. Under certain circumstances, e.g. if the vehicle is rolling on unpaved loose ground (such as loose gravel, mud, snow, or the like), it may be impossible to stop the vehicle by applying the brakes after a substantial unintended rolling speed and momentum have already been attained, because then the wheels will simply lock-up and skid or slide on the loose ground. That can cause a loss of control of the vehicle, or a collision of the vehicle with possible obstacles. This, of course, gives rise to dangerous situations, which occur especially often for inexperienced drivers.

German Patent Application Laying-Open Publication DE 199 41 482 A1 discloses an apparatus for preventing the backward rolling of a vehicle located on a slope. The vehicle is equipped with a braking system that aims to distribute the braking effect between at least one front wheel and one rear wheel. For this purpose, actuators allocated to a rear wheel are operated so as to influence the brake pressure in the wheel brake of at least this rear wheel, in such a manner so that a pressure difference between the respective brake pressures of the front wheel and of the rear wheel is established. The apparatus comprises first means that determine whether the vehicle is at a standstill due to a braking process by which correspondingly a pressure difference between the brake pressures of the front wheel and of the rear wheel has been established. The apparatus further comprises second means that determine whether the vehicle rolls backward out of the standstill. If such a backward rolling of the vehicle is recognized, then the respective brake pressure on at least one rear wheel is increased in order to suppress the backward rolling of the vehicle.

### SUMMARY OF THE INVENTION

In view of the above, it is an object of the invention to provide a method as well as an apparatus or system with which a roll-blocking device such as a brake device can be reliably activated and deactivated, preferably in an automatic manner, so as to avoid or reduce the occurrence of dangerous situations due to unintended rolling of a vehicle. Another more-specific object of the invention is to detect and recognize the actual occurrence or the expected imminent occurrence of an unintended rolling of a vehicle, and to thereupon automatically trigger the activation of a roll-blocking device. The invention further aims to avoid or overcome the disadvantages of the prior art, and to achieve additional advantages, as apparent from the present specification. The attainment of these objects is, however, not a required limitation of the claimed invention.

The above objects have been achieved according to the invention in a method of preventing or blocking the unintended rolling of a vehicle, by detecting or otherwise determining the transmission gear (e.g. forward, neutral, reverse, or a particular gear range or speed of forward or reverse) that is selected, determining whether an unintended rolling of the vehicle actually exists or is to be expected dependent on the selected gear, and automatically activating a roll-blocking device if it is determined that an unintended rolling of the vehicle actually exists or is expected to occur.

More particularly, through the gear detection or recognition, it can be determined whether a forward gear or a reverse gear or no gear at all (e.g. a neutral gear position) is selected or engaged. If a forward gear is selected, then a reverse or backward rolling of the vehicle is especially considered an unintended rolling. Thus, if a forward gear is selected, and a backward or reverse rolling of the vehicle is detected as actually occurring or expected to occur, then the roll-blocking device is activated in order to stop, block or prevent the unintended rolling. On the other hand, if it is recognized that a reverse gear is selected, and simultaneously determined that a vehicle motion (particularly a rolling of the vehicle) in the forward direction exists or is imminently expected to occur, then such forward rolling is considered unintentional, and thus the roll-blocking device is automatically activated. Further, if no gear or a neutral gear is selected (e.g. the vehicle transmission is in a neutral position so that the vehicle drive train is idling without power transmission therethrough), then any vehicle motion (particularly a rolling of the vehicle) in either the forward direction or the reverse or backward direction is considered unintentional, so that the roll-blocking device is automatically activated if any such rolling is detected.

In this regard, the roll-blocking device may be activated and remain activated whenever and as long as the neutral gear position is selected, even if an unintended rolling of the vehicle is not detected. In other words, the vehicle can be braked by the activated roll-blocking device to maintain a standstill of the vehicle whenever the neutral gear position is selected. Of course, this does not pertain for a gear selection intermittently passing through a neutral condition when shifting between successive gears during the driving travel of the vehicle.

Further in this regard, another preferred feature of the invention provides for the automatic deactivation of the roll-blocking device after the expiration of a certain predetermined time interval or duration, especially in the neutral gear condition, in order to prevent the miss-use of the roll-blocking device as a parking or locking brake.

In the context of the present invention, it is not only possible to detect and recognize an actual unintended rolling of the vehicle, but rather it is also possible to estimate or predict whether an unintended rolling of the vehicle is to be expected, e.g. is expected to occur imminently. With such an estimation or prediction, the roll-blocking device can already be activated before the unintended rolling actually occurs. Thereby, the actuation time of the roll-blocking device can be compensated. Thus, there is no time delay between the actual beginning of unintended rolling and the effective actuation of the roll-blocking device, because the actuation is initiated before the actual rolling even begins.

For estimating, predicting or evaluating whether an unintended rolling is to be expected, a preferred embodiment of the invention detects or determines vehicle or driving conditions that can represent an indicator for an imminent rolling of the vehicle. For example, such parameters can involve empirically determined values that are stored in a suitable memory and that specify one or more parameter combinations at which an unintended rolling occurs. Thus, the occurrence of one or more of such parameter combinations can be defined as a triggering or activation criteria upon which the roll-blocking device will be automatically activated. Alternatively, probabilities for the existence or occurrence of an unintended rolling can be determined and compared to previously established probability thresholds. If a prescribed probability threshold is exceeded, then the roll-blocking device is automatically activated. With such a method and system according to the invention, it is possible to increase the safety when a motor vehicle is to drive, or especially begin to drive, on unpaved or off-road terrain or on a steeply sloping roadway.

Situations can arise in which a rolling of the vehicle is desired and intended, for example the backward or reverse rolling of the vehicle even though a forward gear is selected. In order to make this possible, i.e. to allow such intentional rolling contrary to the direction of a selected gear, the roll-blocking device can be switched off or deactivated. Advantageously, the invention provides a clutch condition detection whereby the operating condition or state of the clutch is determined. Particularly, thereby it can also be determined whether the clutch is in an open, partially closed, or completely closed operating condition or state. From this it is possible to determine what torques or moments can be transmitted through the clutch from the engine to the driven wheels or axles of the vehicle. In this regard, modern vehicles are generally equipped with a vehicle data bus on which data signals or values defining the operating condition of the clutch, among other things, are available.

In a preferred variant of the inventive method, the vehicle lengthwise or longitudinal motion is detected in that signals from at least one rotational speed transducer in the drive train or on at least one wheel are detected and evaluated. Particularly, the rotational speed of the engine, of the input of the transmission, of the output of the transmission, and/or of an off-road gearing or transfer case can be detected or determined as the relevant value or values. Alternatively or additionally, a change of the engine rotational speed or of the drive torque can also give an indication of an expected or predicted imminent unintended rolling of the vehicle.

The detection of the vehicle longitudinal motion can be improved if the longitudinal acceleration of the vehicle is determined. In this regard, the pertinent acceleration can be measured, i.e. directly sensed by a suitable acceleration sensor, or can be calculated.

An additional factor or value to be considered in the evaluation for recognizing an imminent unintended rolling, and/or for automatically actuating the roll-blocking device, is the slope or inclination angle of the surface on which the vehicle is to drive, e.g. correspondingly the inclination angle of the vehicle itself relative to a horizontal reference plane. Namely, if such a slope or inclination angle is taken into account, the danger of a renewed unintended rolling of the vehicle upon deactivation of the roll-blocking device can be significantly reduced. In this regard, the slope of the surface on which the vehicle is to drive can be directly measured by a suitable inclination sensor, or can be determined (e.g. calculated) from the vehicle acceleration.

It is possible to evaluate whether an unintended rolling of the vehicle is occurring or is imminently expected to occur, based on the determined value of the inclination angle as discussed above and at least one driving state or condition parameter. Such driving state parameters may, for example, involve the vehicle longitudinal speed and/or the drive torque demanded or selected by the driver and/or the actually existing drive torque. In this regard, for example, it can be concluded that an unintended rolling of the vehicle is occurring or imminently will occur, if the actually existing or available drive torque is not sufficient for driving or beginning to drive in the desired driving direction on the determined inclination or slope. The respective required drive torque that is necessary for driving or beginning to drive in the desired driving direction can be calculated from the determined inclination angle and, if applicable, further known vehicle or driving condition parameters such as the vehicle mass, for example. Then, the actually existing or available drive torque can be compared to the predetermined required drive torque. Thereby an existing or imminently expected unintended rolling is recognized if the actual or available drive torque is less than the predetermined required drive torque and thus is insufficient for preventing a rolling motion of the vehicle in a direction opposite or contrary to the desired driving direction. In other words, for example, the downhill rolling moment of the vehicle is greater than the actual applied drive moment in the uphill direction, so that the vehicle will roll downhill contrary to the desired uphill driving direction.

Through the above evaluation, a threatening or imminent unintended rolling can thus be recognized (i.e. predicted) even before the vehicle actually begins to roll in the undesired direction. For example, a situation may arise, in which the vehicle is being driven uphill on a steep inclined grade, and an improper (too-high) gear is selected. While the vehicle has forward momentum and continues to drive forward up the hill, the drive engine produces insufficient torque and begins to slow down due to the overload. Before the engine stalls due to the overload, an inexperienced driver will instinctively step onto the clutch pedal, thereby disengaging the engine from the drive wheels. Thereupon, the vehicle may continue to roll uphill due to its existing momentum, but the unintended downhill rolling of the vehicle will imminently occur as soon as the forward travel has been decelerated to zero by the counteracting gravitational acceleration. The inventive evaluation enables the recognition of such a situation, so that the roll-blocking device can be automatically activated already before the vehicle actually begins to roll unintentionally downhill, i.e. in a direction opposite the desired uphill driving direction. Particularly, the roll-blocking device can be activated sufficiently early before the expected beginning of downhill rolling of the vehicle, so that the activation time or reaction lag of the roll-blocking device is compensated. Particularly thereby, the roll-blocking device will be activated and come into effect before any or only slight rolling in the unintended direction has taken place.

Advantageously, the invention involves determining a state of the vehicle clutch, the selected or engaged gear, and the position of a vehicle operating element, for example particularly a driving pedal such as the accelerator or gas pedal, or a throttle flap, or the quantity or time point or time duration of the fuel injection of the engine of the vehicle, in order to determine the driver's desire or intention to begin driving, and/or to determine the drive torque being demanded or called-for by the driver, and/or to determine the actually existing or available drive torque. Through these measures, the drive torque or moment at the wheels can be determined or at least estimated (e.g. approximately calculated). From that information, further, especially in combination with the presently existing actual vehicle speed, it can be estimated whether a situation exists in which an unintended rolling of the vehicle is imminently threatening or expected to occur.

If the driver's intention to begin driving, i.e. the driving-start intention, is detected, then the roll-blocking device can be deactivated to allow the vehicle to begin driving. As an example, if a vehicle is stopped on a steep slope and the roll-blocking device is activated, then the roll-blocking device is deactivated as soon as the driver gives indication that he wishes to set the vehicle into motion, i.e. to begin driving the vehicle. In this regard, if the roll-blocking device is already activated at the moment that the driver's driving-start intention is recognized (but before the necessary drive torque is applied to the wheels), then a further renewed unintended rolling of the vehicle downhill, e.g. opposite the desired driving direction, is not completely excluded. In other words, in such a case, it could occur that the vehicle would begin to roll in the opposite direction, before the driving begins in the intended direction. Therefore, preferably the roll-blocking device is first deactivated only after a certain required drive moment or torque exists or is available. This means that the drive torque initiated by the driver and applied to the drive wheels is determined or at least estimated based on the known positions of the clutch or the clutch pedal, the throttle flap or the driving pedal, as well as the engaged transmission gear. Thus, the roll-blocking device is only released or deactivated once the actual applied drive torque exceeds the present required torque, i.e. is great enough to drive the vehicle in the desired direction (e.g. uphill) without allowing the vehicle to roll backward opposite the desired direction. This operation can be improved by further determining the present actually existing slope angle or inclination. From this information it can be determined whether the actual applied drive torque is sufficient to drive the vehicle at the determined inclination angle without allowing the vehicle to roll in a direction opposite the intended driving direction.

In a further variant of the inventive method, the roll-blocking device is deactivated when it is detected or recognized that the vehicle is being prevented from an unintended rolling in another manner, i.e. by means other than the roll-blocking device. For example, the roll-blocking device can be deactivated when the driver has activated the normal parking brake.

In yet another method embodiment of the invention, the roll-blocking device can be deactivated whenever desired, by a corresponding operation or selection carried out by the driver, e.g. especially via an operating element (e.g. a switch, button, lever or the like) provided for this purpose. Thereby it is possible for the driver to deactivate the roll-blocking device whenever desired, so as to purposely allow the vehicle to roll. Such deactivation of the roll-blocking device is especially advantageous in an embodiment in which no automatic recognition of a driving-start process is implemented. Thus, in order to begin driving the vehicle with an automatically activated roll-blocking device, the driver simply needs to operate the provided operating element so as to thereby release or deactivate the roll-blocking device to allow the vehicle to begin driving without hindrance.

Another alternative or optional feature of the invention provides that the roll-blocking device can be deactivated by switching it off. In other words, in the switched-off condition of the system or the roll-blocking device, an automatic activation of the roll-blocking device is not possible. By enabling the driver to selectively switch-on or switch-off the system, the functionality of such a system implementing the inventive method can be expanded and made selectively adaptable to the driver's desires.

The above objects have further been achieved according to the invention in an apparatus or system for preventing or blocking the unintended rolling of a vehicle. The system includes a roll-blocking device such as a friction brake or any other mechanism or device for stopping or blocking the rolling of a vehicle. The system further includes a driving state determination arrangement, as well as a gear recognition arrangement for recognizing or determining a selected or engaged gear, e.g. recognizing wether a forward gear or a reverse gear or no gear (neutral position) is selected or engaged. The system still further includes a control unit that is connected with the gear recognition arrangement and the driving state determination arrangement, and that is adapted to determine whether the roll-blocking device must be activated based on the received gear recognition and vehicle motion information, and that is adapted to correspondingly control or activate the roll-blocking device when necessary. The roll-blocking device must be activated upon the occurrence of a prescribed event or condition, and especially upon the recognition of an unintended rolling or an expected unintended rolling of the vehicle.

With such an apparatus or system, the likelihood of an accident arising due to an unintended rolling of the vehicle can be reduced. The roll-blocking device can comprise a separate brake arrangement, or it can comprise or be integrated with normal operating brakes or lockable parking brakes of the vehicle. In a simple embodiment, the gear recognition arrangement may include one or more sensors, e.g. mechanical, magnetic, electromagnetic, optical, or other sensors arranged in connection with the shift lever or gear selection lever, a gear selection button or other operating element, a shift linkage, a transmission, or any other suitable component of the vehicle in order to sense or detect and thereby recognize whether a forward gear or a reverse gear or no gear (neutral gear) is selected or engaged. In a further embodiment, the gear recognition arrangement can be configured and arranged to additionally recognize which particular forward or reverse gear is selected or engaged. With this information, an expected rolling of the vehicle can be more easily or more accurately estimated or predicted.

In a preferred embodiment of the inventive system, the driving state determination arrangement comprises at least one rotation speed sensor in the drive train and/or on at least one wheel of the vehicle. By these measures, the vehicle longitudinal motion can be determined in a simple manner and by simple means. From the detected vehicle longitudinal motion, together with the recognized gear, it can be determined whether the vehicle is undergoing an unintended rolling motion or whether an unintended rolling motion is imminently expected to occur.

The system preferably further comprises inclination or slope angle detection devices, such as inclination sensors of any known type, in order to determine the inclination angle of the vehicle and/or of the surface on which the vehicle is to drive. From this inclination or slope angle information, it can be estimated whether a drive torque initiated by the driver of the vehicle is sufficient to move the vehicle in the desired direction without rolling in the opposite direction.

Preferably, the roll-blocking device is embodied as a brake arrangement. For example, this brake arrangement may comprise the normal operating brake of the vehicle, which is controlled by the inventive system to automatically brake the wheels of the vehicle in a fixed or locked manner when it is recognized that a certain prescribed event or condition has occurred. Such a prescribed event or condition may, for example, be the recognition of an unintended rolling or the recognition of the expected impending occurrence of an unintended rolling of the vehicle.

In a further embodiment, the system additionally comprises a driving-start intention recognition arrangement adapted to recognize a driver's intention to start driving the vehicle. In this embodiment, the deactivation of the roll-blocking device can be carried out automatically. Namely, if a driving-start intention is recognized, then the roll-blocking device is released or deactivated. Especially, the roll-blocking device is released when the driver's driving-start intention is recognized and additionally it is recognized that the drive torque initiated by the driver is sufficient to drive the vehicle in the desired direction.

The user comfort and adaptability of the inventive system is increased when it further includes an operating element for deactivating the roll-blocking device. Additionally, another operating element can be provided, to selectively switch-on or switch-off the overall system or apparatus as desired by the driver.

### BRIEF DESCRIPTION OF THE DRAWINGS

In order that the invention may be clearly understood, it will now be described in connection with an example embodiment thereof, with reference to the accompanying drawings, wherein:

FIG. 1 is a schematic side view of a motor vehicle on a steeply sloping terrain, whereby the vehicle is equipped with an inventive system for carrying out the inventive method;

FIG. 2 is a schematic block diagram of most-significant components of an example embodiment of an inventive system for preventing or blocking the unintended rolling of the vehicle.

### DETAILED DESCRIPTION OF A PREFERRED EXAMPLE EMBODIMENT AND OF THE BEST MODE OF THE INVENTION

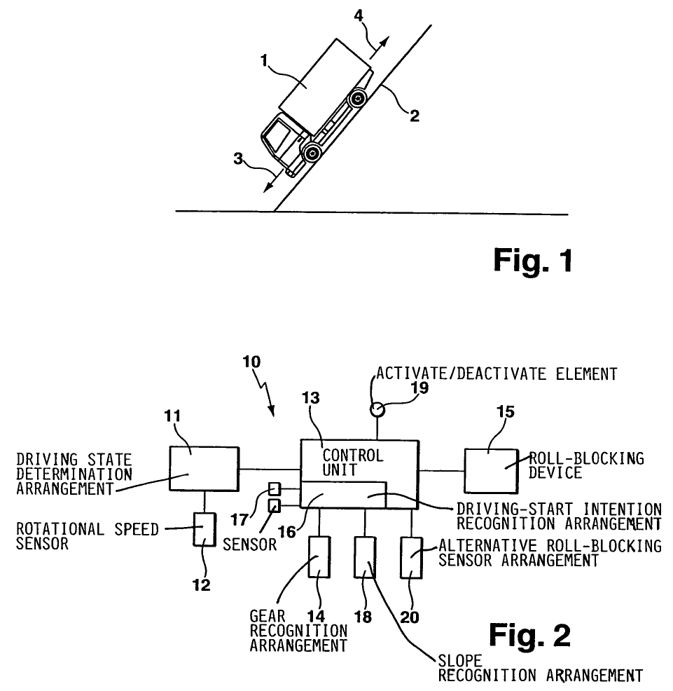

FIG. 1 schematically shows a motor vehicle 1, such as a heavy duty truck, located and to be driven on a steeply sloping terrain 2. The vehicle 1 includes a drive unit comprising a motor (which may be an internal combustion engine, some other combustion engine, an electric motor, etc.), at least one driven wheel, and a drive train including a transmission operatively connected between the drive unit and the at least one driven wheel. The transmission includes plural gears, e.g. at least one forward gear, at least one reverse gear, and at least one neutral gear, which may be respectively individually selected by the driver of the vehicle. The neutral gear may simply mean that no forward gear and no reverse gear is engaged. The transmission may be a manually shiftable transmission, an automatic transmission, a continuously variable transmission, or any other known transmission arrangement. Accordingly, the drive train further includes a clutch if applicable. The vehicle further includes a drive unit control pedal, e.g. a gas pedal or accelerator pedal, for the driver to control the drive unit, as well as other operating elements typical in modern motor vehicles. Furthermore, the vehicle 1 is equipped with a system 10 for blocking an unintended rolling of the vehicle according to the invention, as follows.

In the present example, the vehicle 1 is initially stopped at a standstill, but is to be driven in a desired reverse or rearward uphill direction as shown by arrow 4. However, due to the steep slope of the terrain 2, the influence of gravity gives rise to the danger of an unintended rolling of the vehicle 1 in the forward downhill direction shown by arrow 3 opposite the intended rearward uphill direction 4.

If the vehicle 1 begins to roll unintentionally in the forward downhill direction 3, the vehicle 1 may undergo such a rapid acceleration (e.g. due to the steep slope), that it becomes difficult or impossible to stop the vehicle 1, even if the driver reacts quickly and appropriately, e.g. by rapidly applying the normal operating brakes of the vehicle 1. This danger especially becomes more significant if the steeply sloping terrain 2 is an unpaved off-road terrain or any terrain having loose or slippery characteristics, such as a terrain surface of gravel, sand, mud, snow, or the like. Namely, under such conditions, even after the normal operating brakes of the vehicle have locked the wheels and prevented further rotation thereof, the vehicle 1 may continue to slide in the downhill direction 3 due to the momentum in this direction and the insufficient traction of the wheels on the loose or slippery terrain 2.

Thus, an unintended rolling of the vehicle 1 in the downhill direction 3 must be reliably and assuredly prevented from the beginning, or rapidly stopped once it begins. For this reason, the invention provides a method and a system for blocking (e.g. preventing or stopping) such unintended rolling. For this purpose, the motion of the vehicle 1 and other parameters are detected and evaluated according to the invention.

In the present example of a desired driving of the vehicle 1 in the uphill direction 4, the driver has selected or engaged a reverse gear to begin slowly driving or “backing” up the slope in the direction 4. If, however, the driver has selected and engaged a gear with a gear range that is too high, it can occur that the vehicle engine does not provide sufficient torque and therefore the vehicle 1 will become ever slower because the slope of the terrain 2 is too steep. In order to prevent the stalling of the overloaded engine, the driver might step on the clutch pedal, or an automatic clutch system might automatically operate to disengage the clutch of the vehicle 1, shortly before stalling of the engine. Once the clutch is disengaged, the vehicle would be subject to a downhill acceleration in the direction 3, i.e. ultimately leading to an unintended rolling in the direction 3. According to the invention, this situation is detected or predicted, and a suitable roll-blocking device is automatically activated already before an actual rolling of the vehicle in the downhill direction 3 occurs.

As an alternative example, consider again the starting condition of the vehicle 1 stopped at a standstill. By selecting or engaging a reverse gear, the driver thereby indicates the intention that he wishes to drive the vehicle in the reverse or uphill direction 4. In this example, the inventive system and method can already automatically activate the roll-blocking device upon recognizing the selected gear and no existing vehicle motion, in order to prevent or block an unintended downhill rolling of the vehicle 1 in the direction 3 as the driver begins the reverse driving process, e.g. by releasing the normal operating brake, accelerating the engine rotational speed, and transitioning the clutch from a disengaged state to an engaged state. During that time interval, the danger of an unintended downhill rolling in the direction 3 would otherwise exist without the inventive roll-blocking system. The roll-blocking device is then deactivated when it is recognized that the driver intends to and/or actually is starting to drive in the uphill direction 4, and especially after it is recognized that the actual applied drive torque is sufficient to drive the vehicle 1 in the uphill direction 4.

The roll-blocking device can further be activated, according to the invention, when it is recognized that no gear (e.g. a neutral gear position) is selected in the illustrated situation. In such a neutral gear condition, it can be understood that the driver does not intend any motion of the vehicle 1 to occur, so that any rolling of the vehicle would be regarded as an unintended rolling that is to be blocked.

FIG. 2 schematically illustrates a roll-blocking system or apparatus 10 according to the invention, for blocking (e.g. preventing or stopping) an unintended rolling of a vehicle such as the above discussed vehicle 1. The system 10 includes a driving state determination arrangement 11 that is connected with one or more rotational speed sensors 12 in order to detect or otherwise determine the direction and speed of the longitudinal motion of the vehicle 1. For example, such rotational speed sensors 12 may comprise wheel speed sensors to detect the actual rotational speed (and direction) of one or more wheels, drive train speed sensors to detect the rotational speed (and direction) of any suitable component of the drive train, and/or engine speed sensors to detect the rotational speed of the engine, or any other suitably arranged rotational speed sensors.

The system 10 further includes a control unit 13 and a gear recognition arrangement 14, whereby the control unit 13 is connected with the driving state determination arrangement 11 and the gear recognition arrangement 14. The gear recognition arrangement 14 may comprise one or more sensors to determine the presently selected or engaged transmission gear. The control unit 13 receives suitable signals or data from the arrangements 11 and 14, respectively indicating the recognized speed and direction of the vehicle motion and the selected gear. Based on this information, the control unit 13 determines whether a roll-blocking device 15 of the system 10 is to be activated. The roll-blocking device 15 may be embodied as a brake arrangement acting on one or more wheels, for example. If the control unit 13 determines that an event or condition exists, which requires activation of the roll-blocking device 15, then the control unit 13 suitably controls and activates the roll-blocking device 15 SO as to block (stop or prevent) an unintended rolling of the vehicle 1.

The roll-blocking device 15 is activated when an unintended rolling of the vehicle 1 actually exists or is imminently expected to occur. In this example embodiment, an unintended rolling is designated as a rolling of the vehicle 1 in a direction (e.g. downhill 3) opposite the intended driving direction (e.g. uphill 4), which is recognized from the selected gear according to the invention. If the transmission is in a neutral position or idle condition without transmission of power, then any rolling of the vehicle 1 (in any direction) is regarded as unintended rolling.

Whether an unintended rolling is already actually occurring can be recognized from the longitudinal speed of the vehicle 1. For example, any detected longitudinal speed of the vehicle in an unintended rolling direction indicates that unintended rolling is already occurring. Furthermore, the time point of an imminently expected unintended rolling can be predicted or determined from the presently existing actual longitudinal speed (and/or its variation) and the inclination or slope angle. For example, if no drive torque is applied to the drive wheels of the vehicle, then even an existing uphill speed of the vehicle will be substantially retarded or decelerated by the gravitational acceleration acting downhill. This deceleration can be determined from the known earth's gravitational acceleration and the value of the inclination angle of the terrain 2 on which the vehicle 1 is positioned. From the determined deceleration, the time point of the beginning of the unintended downhill rolling can be determined, and the roll-blocking device 15 can be automatically activated, at the latest at this time point. The particular time point of activating the roll-blocking device 15 can additionally take into account further parameters, such as the characteristics of the brake system (e.g. time constants, activation time, braking pressure, pressure build-up dynamics, etc.), for example. Thereby, an unintended rolling can be blocked, i.e. prevented before it occurs, or terminated directly and immediately after it begins.

Alternatively, an imminently expected unintended rolling of the vehicle can be recognized from the actual existing or applied drive torque and the slope or inclination angle of the pertinent terrain. In this regard, a required drive torque that is necessary for driving or beginning to drive the vehicle on the pertinent slope of the terrain is determined, or has previously been determined, based on the inclination angle and, if applicable, further vehicle parameters. If this required drive torque is greater than the actual available or applied drive torque, then an unintended rolling of the vehicle will imminently occur. The time point of the expected beginning of the unintended rolling can be determined dependent on the presently existing actual longitudinal speed of the vehicle, so that the roll-blocking device 15 can be activated at an appropriate time to prevent the occurrence of the expected unintended rolling.

More particularly, the presently existing actual available or applied drive torque can be determined or at least approximated from several parameters or values of the operating state of the vehicle. For example, such values can be acquired by sensors 17. While FIG. 2 simply shows two sensors 17 as a schematic example, any number and arrangement of sensors could be used for sensing, for example, the operating state or position of the clutch, the operating state or position of a throttle flap of the engine, the operating state or position of a driving pedal such as a gas pedal, and/or the fuel injection quantity, time point or time duration of the engine. Moreover, modern vehicles typically include a vehicle data bus on which the value of the presently existing actual drive torque is available.

The vehicle 1 may be equipped with either a manually operated (e.g. foot-operated) clutch or with an automatic clutch, or a clutch system that can be manually or automatically operated as desired. With a manually (e.g. foot-operated) clutch the operating condition of the clutch can be determined, for example, from the clutch position, which may be very simply detected, for example by means of a pedal position sensor or pedal travel sensor. On the other hand, an automatic clutch system provides a signal or suitable data indicating the clutch operating condition.

The control unit 13 includes a driving-start intention recognition arrangement 16 adapted to recognize the driver's intention to start driving the vehicle. The arrangement 16 further serves for detecting or otherwise determining the drive torque demanded or called-for by the driver and/or the presently existing actual available or applied drive torque. For this purpose, the driving-start intention recognition arrangement 16 is connected with the sensors 17 which detect, for example, the operating condition of the clutch, of the throttle flap, and/or of the gas pedal, or the fuel injection quantity and/or the fuel injection time point or duration. Thus, the arrangement 16 can recognize a driver's driving-start intention based on the sensor signals of the sensors 17 and a signal indicating the selected gear as detected by the gear recognition arrangement 14. If a driving-start intention is thus recognized while the roll-blocking device 15 is activated, then the control unit 13 controls the roll-blocking device 15 so as to deactivate or release the roll-blocking device 15. Thereby the intended driving of the vehicle 1 can proceed without hindrance from the roll-blocking device 15.

As a further preferred detail, a slope recognition arrangement 18 (e.g. including at least one inclination sensor) of the system 10 can detect a slope or inclination angle of the terrain 2 on which the vehicle 1 is to drive. If the slope recognition arrangement 18 detects a slope angle, then the roll-blocking device 15 can be maintained in the activated state, and will only be released or deactivated by the control unit 13 once the actually existing or available drive torque is sufficient to set the vehicle into motion in the desired or intended driving direction at the determined slope angle.

The control unit 13 is further connected with an operating element (e.g. switch, button, lever or the like) by which the roll-blocking device 15 can be deactivated as required by the driver of the vehicle. The control unit 13 can further be connected with suitable arrangements such as an alternative roll-blocking sensor arrangement 20 adapted to determine whether the vehicle is being braked or stopped in a fixed manner by other systems or mechanisms of the vehicle other than the roll-blocking device 15. Particularly, the alternative roll-blocking sensor arrangement 20 can be connected with the vehicle's ordinary operating brake system and/or the vehicle's ordinary lockable parking brake system to determine whether these other systems have locked the brakes and thereby prevented rotation of the wheels and rolling of the vehicle. If the arrangement 20 detects and signals that the vehicle is otherwise prevented from an unintended rolling, then the control unit 13 can deactivate or release the roll-blocking device 15, if it was activated, or prevent an activation thereof if it was not activated.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

1. A method of blocking an unintended rolling of a motor vehicle having a drive unit, at least one drive wheel, and a transmission that is interposed between said drive unit and said drive wheel and that has plural respectively selectable gears including at least a forward gear selectable to drive said vehicle in a forward direction, a reverse gear selectable to drive said vehicle in a reverse direction opposite said forward direction, and a neutral gear selectable to idle said vehicle without driving in either of said directions, wherein said method comprises the steps:
a) determining whether there is any rolling motion of said vehicle in said forward direction or said reverse direction;
b) determining which one of said gears of said transmission is selected as a selected active gear; and
c) automatically activating a roll-blocking device to block any said rolling motion of said vehicle if at least any one or more of the following conditions arises:
a first condition in which said forward gear is said selected active gear and said vehicle is undergoing said rolling motion in said reverse direction,
a second condition in which said reverse gear is said selected active gear and said vehicle is undergoing said rolling motion in said forward direction, and
a third condition in which said neutral gear is said selected active gear and said vehicle is undergoing said rolling motion in either one of said directions.

2. The method according to claim 1, further comprising a step of predicting if an unintended rolling motion of said vehicle is imminently about to occur in said forward direction or said reverse direction, and wherein said conditions in said step c) further include:
a fourth condition in which said forward gear is said selected active gear, said vehicle is not yet undergoing said rolling motion in said reverse direction, and said unintended rolling motion is imminently about to occur in said reverse direction,
a fifth condition in which said reverse gear is said selected active gear, said vehicle is not yet undergoing said rolling motion in said forward direction, and said unintended rolling motion is imminently about to occur in said forward direction, and
a sixth condition in which said neutral gear is said selected active gear, said vehicle is not yet undergoing said rolling motion in either one of said directions, and said unintended rolling motion is imminently about to occur in either one of said directions.

3. A method of blocking an unintended rolling of a motor vehicle, comprising the steps:
a) determining at least one parameter of any occurring longitudinal motion of said vehicle;
b) determining a selected active gear among plural available gears of a transmission of said vehicle;
c) in consideration of at least said at least one parameter of said longitudinal motion and said selected active gear, determining whether an unintended rolling of said vehicle is occurring or is expected to occur; and
d) automatically activating a roll-blocking device to block any rolling of said vehicle if said unintended rolling of said vehicle is occurring or is expected to occur.

4. The method according to claim 3, further comprising determining an operating state of a clutch of said vehicle, and wherein said determining in said step c) further takes said operating state of said clutch into consideration.

5. The method according to claim 3, wherein said determining of said at least one parameter of said longitudinal motion in said step a) comprises detecting and evaluating signals from at least one rotational speed sensor arranged in cooperation with a drive train and/or at least one wheel of said vehicle.

6. The method according to claim 3, wherein said determining of said at least one parameter of said longitudinal motion in said step a) comprises determining a longitudinal acceleration of said vehicle.

7. The method according to claim 3, wherein said determining of said at least one parameter of said longitudinal motion in said step a) comprises determining a direction of said longitudinal motion of said vehicle.

8. The method according to claim 3, wherein said determining of said at least one parameter of said longitudinal motion in said step a) comprises determining a speed of said longitudinal motion of said vehicle.

9. The method according to claim 3, further comprising determining an inclination angle of said vehicle or of a driving surface on which said vehicle is positioned, and wherein said determining in said step c) further takes said inclination angle into consideration.

10. The method according to claim 9, further comprising determining at least one driving state parameter of said vehicle, and wherein said determining in said step c) further takes said at least one driving state parameter into consideration.

11. The method according to claim 10, wherein said at least one driving state parameter comprises at least one parameter selected from the group consisting of an actual applied drive torque being applied to at least one wheel of said vehicle, a demanded drive torque being called-for by a driver of said vehicle, and a required drive torque that is a minimum torque required for driving said vehicle in a selected direction taking at least said inclination angle into consideration.

12. The method according to claim 11, wherein said determining in said step c) determines that said unintended rolling is expected to occur if said actual applied drive torque is less than said required drive torque.

13. The method according to claim 11, wherein said determining of said at least one driving state parameter comprises detecting and/or evaluating at least one of the following:
an operating state of a clutch of said vehicle, said selected active gear, an operating position of a drive unit control pedal of said vehicle, an operating position of a throttle flap of said vehicle, a quantity of a fuel injection, a time point of a fuel injection, and a time duration of a fuel injection.

14. The method according to claim 3, further comprising determining whether there exists a driving-start intention of a driver of said vehicle to start driving said vehicle from a standstill, and wherein said determining in said step c) further takes said driving-start intention into consideration.

15. The method according to claim 14, wherein said determining whether there exists said driving-start intention comprises detecting and/or evaluating at least one of the following:
an operating state of a clutch of said vehicle, said selected active gear, an operating position of a drive unit control pedal of said vehicle, an operating position of a throttle flap of said vehicle, a quantity of a fuel injection, a time point of a fuel injection, and a time duration of a fuel injection.

16. The method according to claim 3, further comprising determining an actual applied drive torque being applied to at least one wheel of said vehicle, comparing said actual applied drive torque to a required drive torque threshold representing a minimum torque required for driving said vehicle under a given driving condition, and deactivating said roll-blocking device if said actual applied drive torque exceeds said required drive torque threshold.

17. The method according to claim 16, further comprising determining an inclination angle of said vehicle or of a driving surface on which said vehicle is positioned and/or determining a demanded drive torque being called-for by a driver of said vehicle, and further comprising determining said required drive torque threshold in consideration of and dependent on at least one of said inclination angle and said demanded drive torque.

18. The method according to claim 3, further comprising checking whether a system of said vehicle other than said roll-blocking device is active to block any rolling of said vehicle, and deactivating said roll-blocking device if said system is active.

19. The method according to claim 3, further comprising deactivating said roll-blocking device in response to an operation of an operation element by a driver of said vehicle, wherein said operation element is provided to enable selective deactivation of said roll-blocking device by said driver.

20. The method according to claim 3, further comprising switching-off and thereby deactivating said roll-blocking device in response to an operation of an operation element by a driver of said vehicle, wherein said operation element is provided to enable selective switching-on and switching-off of said roll-blocking device by said driver.

21. A system for blocking an unintended rolling of a motor vehicle, comprising:
a roll-blocking device arranged and adapted to selectively engage at least one of a drive train and at least one wheel of said vehicle so as to block a rolling rotation of said wheel;
a driving state determination arrangement arranged and adapted to determine at least one driving state of said vehicle;
a gear recognition arrangement arranged and adapted to determine a currently selected active gear among at least a forward gear, a reverse gear and a neutral gear of a transmission of said vehicle; and
a control unit that is connected to said driving state determination arrangement and said gear recognition arrangement so as to receive respective driving state and selected gear signals therefrom, and that is connected to said roll-blocking device so as to output control signals thereto;
wherein said control unit is adapted to determine from said driving state and selected gear signals whether an unintended rolling of said vehicle is occurring or expected to occur, and to produce said control signals in response thereto and dependent thereon so as to correspondingly selectively activate said roll-blocking device.

22. The system according to claim 21, further comprising a sensor that is arranged and adapted to detect an operating state of a clutch of said vehicle, and that is connected to at least one of said control unit and said driving state determination arrangement.

23. The system according to claim 21, wherein said driving state determination arrangement comprises at least one rotational speed sensor arranged to cooperate with at least one of said drive train and said at least one wheel of said vehicle.

24. The system according to claim 21, further comprising an inclination angle determining device connected to said control unit.

25. The system according to claim 21, wherein said roll-blocking device comprises a brake arrangement.

26. The system according to claim 21, further comprising a driving-start intention recognition arrangement that is incorporated in or connected to said control unit and that is adapted to recognize an intention of a driver of said vehicle to start driving said vehicle from a standstill.

27. The system according to claim 21, further comprising an operating element that is connected to said control unit or said roll-blocking device, and that enables a driver of said vehicle to selectively deactivate said roll-blocking device by operation of said operating element.
